(19) United States
(12) Patent Application Publication
(10) Pub. No.: US 2025/0100391 A1
(43) Pub. Date: Mar. 27, 2025

(54) METHOD FOR HEATING A POWERTRAIN AND/OR SUBSYSTEM OF A VEHICLE AND CONTROL ARRANGEMENT CONFIGURED TO PERFORM THE METHOD

(71) Applicant: Scania CV AB, Södertälje (SE)

(72) Inventors: Martin Berglund, Vagnhärad (SE); Daniel Ståhl, Enköping (SE); Karl Vestgöte, Nyköping (SE); Magnus Carlgren, Vagnhärad (SE)

(73) Assignee: Scania CV AB, Södertälje (SE)

(21) Appl. No.: 18/883,085

(22) Filed: Sep. 12, 2024

(30) Foreign Application Priority Data
Sep. 27, 2023 (SE) 2351113-2

(51) Int. Cl. B60L 15/20

(52) U.S. Cl. CPC B60L 15/20

(57) ABSTRACT

A method, performed by a control arrangement, for heating a powertrain and/or a subsystem of a vehicle. Said vehicle comprises an electrical machine configured to provide propulsion power to one or more drive wheels of the vehicle and/or power a power take-off load. The method comprises, when the electrical machine is disconnected from said one or more drive wheels of the vehicle and/or said power take-off load, controlling the electrical machine so as to oscillate between a first rotational speed and a second rotational speed to thereby generate heat.

### TECHNICAL FIELD

The present disclosure relates in general to a method for heating a powertrain and/or a subsystem of a vehicle. The present disclosure further relates in general to a control arrangement configured to heat a powertrain and/or subsystem of a vehicle.

Moreover, the present disclosure relates in general to a computer program and a computer-readable medium. The present disclosure also relates in general to a vehicle.

### BACKGROUND

The efforts to reduce emissions and improve fuel economy of heavy vehicles, such as trucks and buses, has led to the development of vehicles comprising vehicle powertrains including one or more electrical machines serving as propulsion units and being configured to be powered by energy storage devices. Examples of such vehicles include Battery Electric Vehicles (BEVs) as well as various Hybrid Electric Vehicles (HEVs), but are not limited thereto.

Cold starts, i.e. starts at low temperatures, are often problematic for fully electric or hybrid vehicle powertrains. In case the powertrain and the components thereof are cold, they provide higher power losses due to friction losses. The higher power losses increases energy consumption, which in turn reduces the possible operational range of the vehicle for the energy stored onboard the vehicle. Moreover, operation with a cold powertrain may unduly increase the wear of constituent components of the powertrain and thereby reduce the lifetime thereof.

An electric vehicle powertrain may also sometimes become cold during operation of the vehicle, in particular in cold climates, which may have essentially the same effects as described above for cold starts.

The electrical machine of the vehicle powertrain is typically powered by an energy storage device. One of major factors that can reduce the charge-discharge performance of an energy storage device is temperature decrease below the temperature range for which the energy storage device is designed to operate. Therefore, energy storage devices of vehicles need to be conditioned to be able to deliver sufficient charge and power. This is often performed by an external electric heater, a fuel burner or a heat pump. However, this adds external hardware, which in turn may add complexity as well as additional cost.

Various thermal management systems configured to use heat generated from the electrical machine to heating various subsystems of a vehicle are previously known. For example, a temperature regulating circuit for the electrical machine may be integrated with a temperature regulating circuit of an energy storge device configured to power the electrical machine and/or a conditioning system for an occupant compartment.

### SUMMARY

The object of the present invention is to provide an improved solution for heating a powertrain and/or a subsystem of a vehicle.

The object is achieved by the subject-matter of the appended independent claim(s).

In accordance with the present disclosure, a method for heating a powertrain and/or a subsystem of a vehicle is provided. The method is performed by a control arrangement The vehicle comprises an electrical machine configured to provide propulsion power to one or more drive wheels of the vehicle and/or power a power take-off load. The method comprises a step of, when the electrical machine is disconnected from said one or more drive wheels of the vehicle and/or said power take-off load, controlling the electrical machine so as to oscillate between a first rotational speed and a second rotational speed to thereby generate heat.

By means of the herein described method, heat is generated by the electrical machine using the inertia thereof during fast acceleration and deceleration of the electrical machine. Thereby, the electrical machine may be conditioned and the generated heat can also be used for heating other components and/or systems of the vehicle. The herein described method also has the advantage of not requiring additional hardware, such as an added heater, and can thereby be utilized on all electric or hybrid vehicles regardless of the specification of the vehicle.

The step of controlling the electrical machine so as to oscillate between a first rotational speed and a second rotational speed may comprise controlling the electrical machine to oscillate between a first rotational speed and a second rotational speed of a power-speed curve of the electrical machine. This allows having the first and second rotational speeds at high power, which in turn enables a high power output and thereby a high amount of heat generated. The power-speed curve may preferably be a maximum power-speed curve of the electrical machine as this allows as much heat as possible to be generated by the electrical machine.

The first and second rotational speeds of the power-speed curve may for example be arranged on opposite sides of a rotational speed corresponding to a peak of the power-speed curve of the electrical machine. Thereby, the electrical machine may oscillate about the maximum power speed, which results in a high heating effect.

In case the power-speed curve comprises a plateau, at least one of said first and second rotational speeds may be within the plateau of the power-speed curve of the electrical machine. This may e.g. facilitate the control of the electrical machine in case the power-speed curve is steep on one or more sides of the plateau, which in turn ensures a high heating effect.

The step of controlling the electrical machine so as to oscillate between a first rotational speed and a second rotational speed may alternatively comprise altering direction of rotation of the electrical machine. In such a case, the first rotational speed is a positive rotational speed whereas the second rotational speed is a negative rotational speed, or vice versa. This may reduce the frequency of the oscillation compared to if oscillating between two rotational speed (having the same rotational direction) of a power-speed curve, which in turn may reduce the noise generated and/or reduce wear of the electrical machine.

The method may further comprise a step of using the heat generated by the electrical machine to heat the subsystem of the vehicle. This may in turn improve the performance and/or efficiency of the subsystem.

The herein described method also has the advantage of being able to use while the vehicle is in motion, which may be advantageous for example in cold climates. For example, the method may be performed during coasting of the vehicle. Alternatively, in case the vehicle comprises a first powertrain comprising the electrical machine, and a second powertrain being separate from the first powertrain, the method may be performed while the vehicle is propelled by the second powertrain.

The present disclosure further relates to a computer program comprising instructions which, when executed by a computer, cause the computer to carry out the method as described above.

The present disclosure further relates to a computer-readable medium comprising instructions which, when executed by a computer, cause the computer to carry out the method as described above.

The present disclosure also provides a control arrangement configured to heat a powertrain and/or a subsystem of a vehicle, said vehicle comprising an electrical machine configured to provide propulsion power to one or more drive wheels of the vehicle and/or power a power take-off load. The control arrangement is configured to, when the electrical machine is disconnected from said one or more drive wheels of the vehicle and/or said power take-off load, controlling the electrical machine so as to oscillate between a first rotational speed and a second rotational speed to thereby generate heat.

The control arrangement provides the same advantages as described above with reference to the corresponding method for heating a powertrain and/or a subsystem of a vehicle.

As previously mentioned, the first and second rotational speeds may correspond to a first rotational speed and a second rotational speed of a power-speed curve of the electrical machine, preferably a maximum power-speed curve of the electrical machine. Alternatively, the first rotational speed is a positive rotational speed whereas the second rotational speed is a negative rotational speed of the electrical machine, or vice versa.

The present disclosure also relates to a vehicle comprising the control arrangement described above. Said vehicle may comprise a single powertrain or a plurality of vehicle powertrains separated from each other. The vehicle may comprise an electrical machine configured to provide propulsion power to one or more drive wheels of the vehicle, and optionally power a power take-off load. In such a case, the electrical machine is part of a powertrain of the vehicle. Alternatively, the vehicle may comprise an electrical machine configured to only power a power take-off load. In such a case, the electrical machine used for performing the herein described method does not constitute a part of a powertrain of the vehicle.

The vehicle may be a land-based vehicle comprising a single vehicle unit, or be a land-based vehicle combination comprising at least two vehicle units. In case of the vehicle comprising more than one vehicle unit, one or more of said vehicle units may comprise its own powertrain(s). The vehicle may for example be a heavy vehicle. Moreover, the vehicle may be a pure electric vehicle, a hybrid vehicle, or be a vehicle driven solely by a combustion engine (but in such a case fitted with an electric power take-off).

Furthermore, the vehicle may be a vehicle configured to a driven fully or in part by a driver. Such a driver may be present onboard the vehicle or be remote from the vehicle, such as at a control center or the like. Alternatively, the vehicle may be a fully autonomous vehicle.

### BRIEF DESCRIPTION OF DRAWINGS

FIG. 1 schematically illustrates a side view of an example of a vehicle,

FIG. 2 schematically illustrates an example of a powertrain of a vehicle,

FIG. 3 represents a flowchart schematically illustrating one exemplifying embodiment of the herein described method,

FIG. 4 schematically illustrates the rotational speed of the electrical machine over time when the herein described method is performed,

FIG. 5 illustrates a first example of a maximum power-speed curve of an electrical machine,

FIG. 6 illustrates a second example of a maximum power-speed curve of an electrical machine, and

FIG. 7 schematically illustrates an exemplifying embodiment of a device which may comprise, consist of, or be comprised in a control arrangement configured to perform the herein described method.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

A vehicle is in the present disclosure considered to mean any means that may be used for transporting people and/or cargo. A vehicle may consist of a single vehicle unit. Examples of a vehicle consisting of a single vehicle unit includes a car, a rigid truck, a tractor truck, a bus, a self-powered trailer, or a self-powered dolly, but are not limited thereto. Alternatively, a vehicle may constitute a vehicle combination comprising at least two vehicle units which are linked together when travelling. A vehicle combination may be a vehicle comprising a tractor vehicle and at least one trailing vehicle. Examples of vehicle combinations include a semi-trailer truck, a rigid truck pulling a semitrailer using a dolly, or a vehicle train comprising a rigid truck and one or more trailers, but are not limited thereto.

Vehicle powertrains usually comprises at least one power unit connected to the drive wheels of the vehicle via one or more transmission units and various shafts. In addition to propelling the vehicle, a vehicle powertrain may also be used to drive one or more auxiliary power consumers. Examples of auxiliary power consumers include pumps, cranes, concrete mixers, compressors or the like, but are not limited thereto. For the purpose of enabling powering one or more such auxiliary power consumers, the vehicle may comprise one or more power take-offs operatively connected to the vehicle powertrain and configured to transmit energy from the vehicle powertrain to an auxiliary power consumer connected thereto. It is also possible to arrange an electric power take-off (sometimes referred to as an E-PTO) in a vehicle, which need not be connected to the powertrain of the vehicle. Instead, such an electric power take-off comprises its own power source (i.e. an electrical machine powered by an energy storage device) configured to power the auxiliary power consumer. In the present disclosure, the above described auxiliary power consumer(s) are, irrespectively of being powered by a separate electrical machine therefore or an electrical machine comprised in the vehicle powertrain, considered to constitute a power take-off load when operatively connected to the power take-off.

The herein described method has primarily been developed for use in such cases where the electrical machine used for performing the method constitutes a part of a powertrain of a vehicle. However, the same solution may be used in case the electrical machine is comprised in an E-PTO and not connected to a powertrain of the vehicle, for example an E-PTO fitted to a combustion engine driven vehicle.

The present disclosure relates to a method, performed by a control arrangement, for heating a powertrain and/or a subsystem of a vehicle. The vehicle comprises at least one electrical machine which may be configured to provide propulsion power to one or more drive wheels of the vehicle, and optionally also power a power take-off (PTO) load. Alternatively, the electrical machine of the vehicle may be configured to only power a power take-off load. In the latter case, the electrical machine is not connected to the drive wheel(s) of the vehicle. The electrical machine may typically be powered by an energy storage device. The electrical machine may be speed controlled by means of an inverter. The inverter allows for control of rotational speed of the electrical machine by varying frequency and/or voltage and/or phase of the voltage being fed to the electrical machine. The inverter may use a DC link voltage (from the energy storage device) from which AC voltages of suitable frequency and amplitude are formed.

In case the electrical machine is configured to provide propulsion power to one or more drive wheels of the vehicle, the herein described method comprises a step of, when the electrical machine is disconnected from said one or more drive wheels of the vehicle, controlling the electrical machine so as to oscillate between a first rotational speed and a second rotational speed to thereby generate heat. In case the electrical machine is configured to both provide propulsion power to one or more drive wheels of the vehicle and power a PTO load, the step of controlling the electrical machine so as to oscillate between a first rotational speed and a second rotational speed to thereby generate heat is performed when the electrical machine is disconnected from said one or more drive wheels as well as disconnected from said PTO load.

In case the electrical machine is merely configured to power a PTO load (i.e. not configured to provide propulsion power to one or more drive wheels of the vehicle), the method comprises a step of, when the electrical machine is disconnected from said PTO load, controlling the electrical machine so as to oscillate between a first rotational speed and a second rotational speed to thereby generate heat.

Described differently, the herein described method comprises a step of controlling the electrical machine of the vehicle to oscillate between a first rotational speed and a second rotational speed when the electrical machine is not subjected to a load, said load resulting from the electrical machine being connected to one or more drive wheels of the vehicle and/or a PTO load. Instead, the herein described method relies on the utilization of the inertia of the electrical machine (and an associated inverter) to load the electrical machine and thereby generate power. The generated power will inherently heat the electrical machine, and may also be used for heating various sub-systems of the vehicle. The subsystem of the vehicle may for example be a temperature regulating circuit (such as a cooling circuit), a lubrication circuit, an energy storage device (such as a battery pack or the like), or an occupant compartment (such as a driver cab), but is not limited thereto. Furthermore, controlling the electrical machine to oscillate between the first and second rotational speeds also means that energy will be discharged from the energy storage device powering the electrical machine, which in turn also contributes (albeit to a lower extent) in heating of such an energy storage device. This means that the energy storage device may be conditioned both from the inside of battery cells of the energy storage device due to discharging, as well as from the outside by e.g., a temperature regulating circuit.

Controlling the electrical machine to oscillate between a first rotational speed and a second rotational speed is in the present disclosure intended to mean controlling the electrical machine to repeatedly and regularly vary between the first and second rotational speeds, essentially without remaining at the first or the second rotational speeds. The oscillation between the first and second rotational speeds is achieved by fast acceleration and deceleration of the electrical machine. It should here be noted that changing from acceleration to deceleration, or vice versa, of the electrical machine takes a certain amount of time. Therefore, “essentially without remaining at the first or the second rotational speed” should here be interpreted as the duration at either one of the first or the second rotational speed being less than 5 seconds, preferably less than 2 seconds. Preferably, the change from acceleration to deceleration, or vice versa, should be performed as quickly as possible. This is because the inertia of the electrical machine will quickly be overcome if remaining at a constant rotational speed, which in turn removes the load of the electrical machine and thereby also does not result in any power produced by the electrical machine.

The herein described method may be performed while the vehicle is at standstill, such as when starting up the vehicle after a longer stop (such as an overnight stop) or during a temporary stop (such as during loading, at a traffic stop, or the like). However, the method may also be performed while the vehicle is in motion. For example, the method may be performed while the vehicle is coasting, or in the case of a hybrid powertrain, while the electrical machine is disconnected from the powertrain and the vehicle is driven by a combustion engine. Alternatively, in case the vehicle comprises two separate powertrains, the herein described method may be performed while the vehicle is propelled by the powertrain which does not comprise the electrical machine controlled to oscillate between the first and second rotational speeds.

According to a first embodiment of the herein described method, the step of controlling the electrical machine so as to oscillate between a first rotational speed and a second rotational speed may suitably comprise controlling the electrical machine to oscillate between a first rotational speed and a second rotational speed of a power-speed curve of the electrical machine. This allows having the first and second rotational speeds at high power, which in turn enables a high power output and thereby a high amount of heat generated. Furthermore, this avoids having to alter the direction of the rotational speed of the electrical machine. This has the advantage of the electric machine not having to pass zero speed and thereby limit the available electrical machine power. Also comfort disturbance caused by inertia may be reduced.

The power-speed curve is preferably the maximum power-speed curve of the electrical machine to enable as much heat as possible to be generated. As known to a person skilled in the art, a maximum power-speed curve of an electrical machine defines the constraints of the electrical machine. The present disclosure is however not limited to controlling the electrical machine to oscillate between a first and a second rotational speed of the maximum power-speed curve of the electrical machine. For example, the power-speed curve used could alternatively be a power-speed curve that is offset from the maximum power-speed curve by a predetermined offset, such as by a preselected percentage or value. This could for example be the case if a power (or torque) limitation for the electrical machine, inverter and/or energy storage device (configured to power the electrical machine) is active.

According to a second embodiment of the herein described method, the step of controlling the electrical machine to oscillate between a first rotational speed and a second rotational speed may comprise altering direction of rotation of the electrical machine. In other words, the first rotational speed may be a positive rotational speed whereas the second may be a negative rotational speed, or vice versa.

The method may further comprise a step of using the heat generated by the electrical machine to heat a subsystem of the vehicle. Thereby, the performance and/or efficiency of the subsystem may be improved. For example, in case the subsystem of the vehicle is an energy storage device, heating the energy storage device may improve the efficiency in the charging/discharging cycle and reduce the risk for damage of the energy storage device. Energy storage devices currently used in the automotive industry typically has a relatively narrow optimal temperature range, and may therefore sometimes need to be heated in e.g. cold climates. In case the subsystem is a lubrication circuit, heating of the lubricant may for example reduce the pump work needed in order to circulate the lubricant within the circuit, which in turn reduces the energy consumption thereof. Moreover, in case the subsystem is a conditioning system for an occupant compartment, the energy consumption for heating the occupant compartment may be reduced since less heat may be needed from a heating device of said system.

The performance of the herein described method for heating a powertrain and/or a subsystem of a vehicle may be governed by programmed instructions. These programmed instructions may take the form of a computer program which, when executed by a computer, cause the computer to effect desired forms of control action. Such a computer may for example be comprised in the control arrangement as described herein. A computer is in the present disclosure considered to mean any hardware or hardware/firmware device implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, an application-specific integrated circuit, or any other device capable of electronically performing operations in a defined manner.

The above described programmed instructions, which may take the form of a computer program, may be stored on a computer-readable medium. Hence, the present disclosure also relates to a computer-readable medium storing instructions, which when executed by computer, cause the computer to carry out the herein described method for heating a powertrain and/or a subsystem of a vehicle. The computer-readable medium may be a non-transitory computer-readable medium, such as a tangible electronic, magnetic, optical, infrared, electromagnetic, and/or semiconductor system, apparatus, and/or device.

The present disclosure further relates to a control arrangement configured to heat a powertrain and/or a subsystem of a vehicle. The control arrangement may be configured to perform any one of the steps of the method for heating a powertrain and/or a subsystem of a vehicle as described herein.

More specifically, a control arrangement configured to heat a powertrain and/or a subsystem of a vehicle is provided. Said vehicle comprises an electrical machine configured to provide propulsion power to one or more drive wheels of the vehicle and/or power a power take-off load. The control arrangement is configured to, when the electrical machine is disconnected from said one or more drive wheels of the vehicle and/or said power take-off load, controlling the electrical machine so as to oscillate between a first rotational speed and a second rotational speed to thereby generate heat.

The control arrangement may comprise one or more control units. In case of the control arrangement comprising a plurality of control units, each control unit may be configured to control a certain function/step or a certain function/step may be divided between more than one control units. The control arrangement may be a control arrangement of electrical machine, or of a powertrain comprising the electrical machine. Alternatively, the control arrangement may be any other control arrangement of the vehicle, but configured to communicate with the electrical machine for the purpose of performing the herein described method.

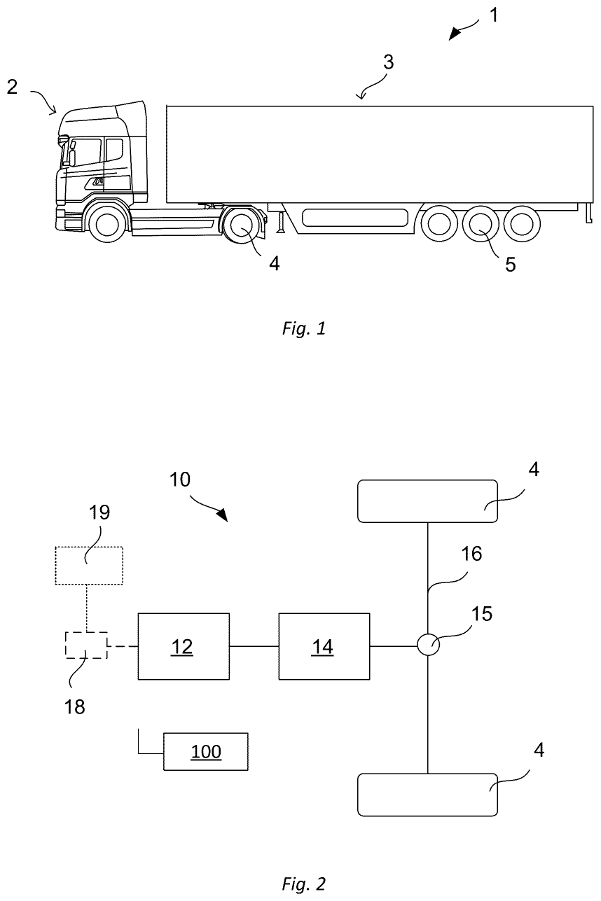

FIG. 1 schematically illustrates a side view of an example of a vehicle 1, here illustrated as a semi-trailer truck. The vehicle 1 may comprise a first vehicle unit 2, here illustrated as a trailer tractor, and a second vehicle unit 3, here illustrated as a semi-trailer. The first vehicle unit 2 comprises a vehicle powertrain configured to provide propulsion power to one or more drive wheels 4 of the first vehicle unit 2. Moreover, the second vehicle unit 3 may optionally also comprise a vehicle powertrain configured to provide propulsion power to one or more drive wheels 5 of the second vehicle unit 3. If present, the vehicle powertrain of the second vehicle unit 3 may have the same configuration as the vehicle powertrain of the first vehicle unit 2, or have a different configuration.

FIG. 2 schematically illustrates an example of a vehicle powertrain 10, such as a vehicle powertrain of the first vehicle unit 2 of the vehicle 1 shown in FIG. 1. The vehicle powertrain 10 comprises at least one electrical machine 12, which may be powered by an energy storage device (not shown). The electrical machine 12 is configured to transmit propulsion power to one or more drive wheels 4 via a transmission unit 14 and a drive shaft 16. The transmission unit 14 may optionally be connected to the drive shaft via a differential 15. The transmission unit 14 may be a single speed transmission unit, or a multispeed transmission unit. The transmission unit 14, the optional differential 16 and the drive shaft 16 are all constituent components of the vehicle powertrain 10. Although not illustrated in the figure, the vehicle powertrain 10 may further comprise a combustion engine, if desired. The vehicle powertrain 10 may for example be a parallel hybrid powertrain or a series hybrid powertrain.

Furthermore, the vehicle powertrain 10 may optionally further comprise a power take-off 18 connected to the electrical machine 12. By means of the power take-off 18, the electrical machine 12 may also be configured to power an auxiliary power consumer 19. It should here be noted that the auxiliary power consumer does not constitute a constituent component of the vehicle powertrain 10.

The vehicle powertrain 10 may further comprise a control arrangement 100 configured to control parts of, or the whole, vehicle powertrain 10. The control arrangement 100 may for example be configured to at least control the electrical machine 12. The control arrangement 100 may be configured to perform the herein described method for heating a powertrain and/or a subsystem of a vehicle.

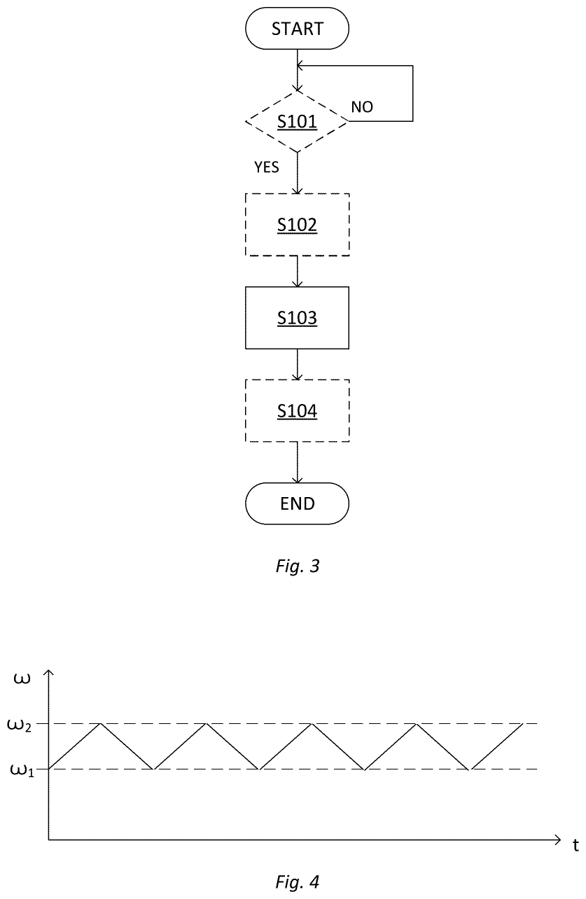

FIG. 3 schematically illustrates one exemplifying embodiment of the herein described method for heating a powertrain and/or a subsystem of a vehicle. Optional steps are illustrated by dashed lines.

The method may comprise a step S101 of determining whether a command for heating of the powertrain and/or a subsystem of the vehicle using the electrical machine has been generated. If no such command has been generated, the method may revert to start. However, if said command has been generated, the method may proceed to a subsequent step.

The method may also comprise a step S102 of disconnecting the electrical machine from drive wheel(s) of the vehicle and a possible power take-off load, if not already disconnected therefrom.

The method comprises a step S103 of controlling the electrical machine so as to oscillate between a first rotational speed and a second rotational speed so as to generate heat. Step S103 is performed while the electrical machine is disconnected from drive wheel(s) of the vehicle as well as a possible power take-off load.

The method may further comprise a step S104 of using the heat generated by the electrical machine to heat a subsystem of the vehicle.

Thereafter, the method may be ended.

FIG. 4 schematically illustrates the rotational speed of the electrical machine over time when the electrical machine is controlled to oscillate between a first rotational speed [symbol] and a second rotational speed [symbol] ₂ in accordance with the herein described method. As can be seen from the figure, the electrical machine is repeatedly accelerated and decelerated.

Depending on e.g. the configuration of an electrical machine, a maximum power-speed curve thereof may have different shapes. In general, the maximum power increases with rotational speed up to a certain rotational speed which may define a maximum peak power or the start of a plateau of constant, increasing, or decreasing power with increasing rotational speed. At rotational speeds above the peak or plateau, the maximum power again decreases with increasing rotational speed of the electrical machine.

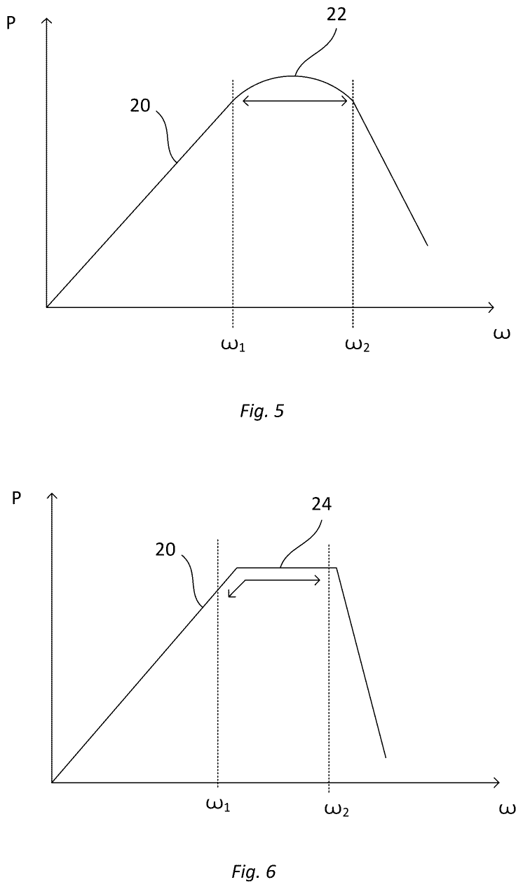

FIG. 5 schematically illustrates an example of a maximum power-speed curve 20 of an electrical machine, said curve comprising a single maximum peak 22. In such a case, the first rotational speed [symbol] and the second rotational speed [symbol] , between which the electrical machine is controlled to oscillate (as shown by the arrow), may suitably be on opposite sides of the peak 22 to obtain the highest heating effect.

FIG. 6 schematically illustrates a second example of a maximum power-speed curve 20 of an electrical machine, wherein the maximum power-speed curve comprises a plateau 24. The plateau 24 is here illustrated as a constant power plateau. It should however be noted that the plateau 24 may alternatively have an increasing or decreasing power with increasing speed of the electrical machine. If the inclination of the power-speed curve 20 is steep on one side the plateau 24, as shown in the figure at rotational speeds above the plateau 24, it may be beneficial to have the one of the rotational speeds within the plateau 24 e.g., to reduce the risk for overrevving the electrical machine. In the figure, the second rotational speed [symbol] is shown to be within the plateau 24. In case the power-speed curve 20 is steep on both sides of the plateau 24, both the first and second rotational speeds [symbol] , [symbol] may be within the plateau. Naturally, it is however also possible the first and second rotational speeds [symbol] , [symbol] ₂ are both outside of the plateau; in such a case preferably on opposite sides of the plateau.

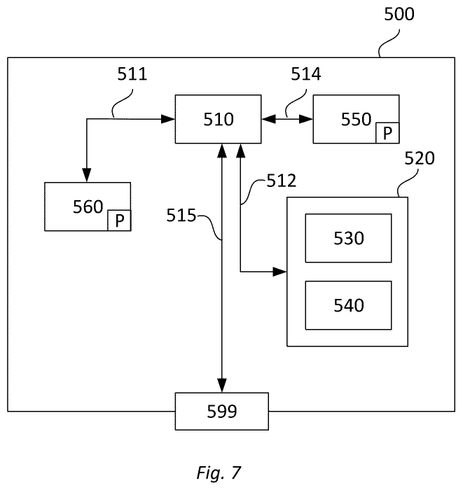

FIG. 7 schematically illustrates an exemplifying embodiment of a device 500. The control arrangement 100 described above may for example comprise the device 500, consist of the device 500, or be comprised in the device 500.

The device 500 comprises a non-volatile memory 520, a data processing unit 510 and a read/write memory 550. The non-volatile memory 520 has a first memory element 530 in which a computer program, e.g., an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

There is provided a computer program P that comprises instructions for heating a powertrain and/or a subsystem of a vehicle, wherein said vehicle comprises an electrical machine configured to provide propulsion power to one or more drive wheels of the vehicle and/or power a power take-off load. The computer program comprises instructions for, when the electrical machine is disconnected from said one or more drive wheels of the vehicle and/or said power take-off load, controlling the electrical machine so as to oscillate between a first rotational speed and a second rotational speed to thereby generate heat.

The program P may be stored in an executable form or in a compressed form in a memory 560 and/or in a read/write memory 550.

The data processing unit 510 may perform one or more functions, i.e. the data processing unit 510 may effect a certain part of the program P stored in the memory 560 or a certain part of the program P stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicate with the data processing unit 510 via a data bus 514. The communication between the constituent components may be implemented by a communication link. A communication link may be a physical connection such as an optoelectronic communication line, or a non-physical connection such as a wireless connection, e.g., a radio link or microwave link.

When data are received on the data port 599, they may be stored temporarily in the second memory element 540. When input data received have been temporarily stored, the data processing unit 510 is prepared to effect code execution as described above.

1. A method, performed by a control arrangement, for heating a powertrain and/or a subsystem of a vehicle,
said vehicle comprising an electrical machine configured to provide propulsion power to one or more drive wheels of the vehicle and/or power a power take-off load,
the method comprising:
when the electrical machine is disconnected from said one or more drive wheels of the vehicle and/or said power take-off load, controlling the electrical machine so as to oscillate between a first rotational speed and a second rotational speed to thereby generate heat.

2. The method according to claim 1, wherein controlling the electrical machine so as to oscillate between a first rotational speed and a second rotational speed comprises controlling the electrical machine to oscillate between a first rotational speed and a second rotational speed of a power-speed curve of the electrical machine.

3. The method according to claim 2, wherein the first and second rotational speeds of the power-speed curve are arranged on opposite sides of a rotational speed corresponding to a peak of the power-speed curve of the electrical machine.

4. The method according to claim 2, wherein at least one of said first and second rotational speeds is within a plateau of the power-speed curve of the electrical machine.

5. The method according to claim 1, wherein controlling the electrical machine so as to oscillate between a first rotational speed and a second rotational speed comprises altering direction of rotation of the electrical machine.

6. The method according to claim 1, further comprising using heat generated by the electrical machine to heat the subsystem of the vehicle.

7. The method according to claim 1, wherein the method is performed while the vehicle is in motion.

8. The method according to claim 7, wherein the method is performed during coasting.

9. The method according to claim 7, wherein
the vehicle comprises:
a first powertrain comprising the electrical machine, and
a second powertrain being separate from the first powertrain,
and wherein the method is performed while the vehicle is propelled by the second powertrain.

10. A computer program product stored on a non-transitory computer-readable medium, said computer program product for heating a powertrain and/or a subsystem of a vehicle, said vehicle comprising an electrical machine configured to provide propulsion power to one or more drive wheels of the vehicle and/or power a power take-off load, wherein said computer program product comprising computer instructions to cause one or more computing devices to perform the following operations:
when the electrical machine is disconnected from said one or more drive wheels of the vehicle and/or said power take-off load, controlling the electrical machine so as to oscillate between a first rotational speed and a second rotational speed to thereby generate heat.

11. (canceled)

12. A control arrangement configured to heat a powertrain and/or a subsystem of a vehicle,
said vehicle comprising an electrical machine configured to provide propulsion power to one or more drive wheels of the vehicle and/or power a power take-off load,
wherein the control arrangement is configured to, when the electrical machine is disconnected from said one or more drive wheels of the vehicle and/or said power take-off load, control the electrical machine so as to oscillate between a first rotational speed and a second rotational speed to thereby generate heat.

13. The control arrangement according to claim 12, wherein the first and second rotational speeds correspond to a first rotational speed and a second rotational speed of a power-speed curve of the electrical machine.

14. The control arrangement according to claim 12, wherein the first rotational speed is a positive rotational speed, and the second rotational speed is a negative rotational speed or vice versa.

15. A vehicle comprising a control arrangement configured to heat a powertrain and/or a subsystem of a vehicle,
said vehicle comprising an electrical machine configured to provide propulsion power to one or more drive wheels of the vehicle and/or power a power take-off load,
wherein the control arrangement is configured to, when the electrical machine is disconnected from said one or more drive wheels of the vehicle and/or said power take-off load, control the electrical machine so as to oscillate between a first rotational speed and a second rotational speed to thereby generate heat.

16. The method according to claim 1, wherein controlling the electrical machine so as to oscillate between a first rotational speed and a second rotational speed comprises controlling the electrical machine to oscillate between a first rotational speed and a second rotational speed of a power-speed curve of the electrical machine, wherein the power-speed curve is a maximum power-speed curve of the electrical machine.

17. The control arrangement according to claim 12, wherein the first and second rotational speeds correspond to a first rotational speed and a second rotational speed of a power-speed curve of the electrical machine, wherein the power-speed curve is a maximum power-speed curve of the electrical machine.
